(19) United States
(12) Patent Application Publication
(10) Pub. No.: US 2022/0027708 A1
(43) Pub. Date: Jan. 27, 2022

(54) ARITHMETIC APPARATUS, ACTION DETERMINATION METHOD, AND NON-TRANSITORY COMPUTER READABLE MEDIUM STORING CONTROL PROGRAM

(71) Applicant: NEC Corporation, Minato-ku, Tokyo (JP)

(72) Inventors: Tatsuya MORI, Tokyo (JP); Takuya HIRAOKA, Tokyo (JP); Voot TANGKARATT, Saitama (JP)

(73) Assignee: NEC Corporation, Minato-ku, Tokyo (JP)

(21) Appl. No.: 17/311,752

(22) PCT Filed: Dec. 13, 2018
(86) PCT No.: PCT/JP2018/045947

§ 371 Date: Jun. 8, 2021

(51) Int. Cl. G06N 3/04

(52) U.S. Cl. CPC G06N 3/0454

(57) ABSTRACT

In an arithmetic apparatus (10), a prediction state determination unit (11) determines a plurality of prediction states for each of a plurality of candidate actions that can be executed in a first state by using a plurality of transition information units. A degree of variation calculation unit (12) calculates degrees of variation of the plurality of prediction states determined for each of the plurality of candidate actions by the prediction state determination unit (11). A candidate action selection unit (13) selects some of the candidate actions among the aforementioned plurality of candidate actions based on the plurality of degrees of variation calculated by the degree of variation calculation unit (12).

### TECHNICAL FIELD

The present disclosure relates to an arithmetic apparatus, an action determination method, and a control program.

### BACKGROUND ART

Various kinds of research on “reinforcement learning” have been carried out (e.g., Non-Patent Literature 1). One of the purposes of reinforcement learning is to perform a plurality of actions against a real environment on a time-series basis, thereby learning a policy that maximizes a “cumulative reward” obtained from the real environment.

### CITATION LIST

### Non Patent Literature

Non-Patent Literature 1: Richard S. Sutton and Andrew G. Barto, “Reinforcement Learning: An Introduction”, Second Edition, MIT Press, 2018

### SUMMARY OF INVENTION

### Technical Problem

Incidentally, in order to efficiently learn suitable policies, it is necessary to efficiently search for (explore) a “state space” for the state of a real environment.

However, although Non-Patent Literature 1 mentions the importance of searching (exploring), it fails to disclose a specific technique for enabling an efficient search (exploration).

An object of the present disclosure is to provide an arithmetic apparatus, an action determination method, and a control program that enable an efficient search (exploration).

### Solution to Problem

An arithmetic apparatus according to a first aspect includes: determination means for determining, by using a plurality of pieces of transition information each indicating a relation between a first state at a first timing and a second state at a second timing after the first timing, a plurality of the second states for each of a plurality of candidate actions that can be executed in the first state; calculation means for calculating degrees of variation of the plurality of the second states for each of the candidate actions; and selection means for selecting some of the candidate actions from among the plurality of the candidate actions based on the degrees of variation.

An action determination method according to a second aspect includes: causing an information processing apparatus to determine, by using a plurality of pieces of transition information each indicating a relation between a first state at a first timing and a second state at a second timing after the first timing, a plurality of the second states for each of a plurality of candidate actions that can be executed in the first state; calculating degrees of variation of the plurality of the second states for each of the candidate actions; and selecting some of the candidate actions from among the plurality of the candidate actions based on the degrees of variation.

A control program according to a third aspect causes an arithmetic apparatus to: determine, by using a plurality of pieces of transition information each indicating a relation between a first state at a first timing and a second state at a second timing after the first timing, a plurality of the second states for each of a plurality of candidate actions that can be executed in the first state; calculate degrees of variation of the plurality of the second states for each of the candidate actions; and select some of the candidate actions from among the plurality of the candidate actions based on the degrees of variation.

### Advantageous Effects of Invention

According to the present disclosure, it is possible to provide an arithmetic apparatus, an action determination method, and a control program that enable an efficient search (exploration).

### BRIEF DESCRIPTION OF DRAWINGS

FIG. 1 is a block diagram showing an example of an arithmetic apparatus according to a first example embodiment;

FIG. 2 is a block diagram showing an example of a control apparatus including an arithmetic apparatus according to a second example embodiment;

FIG. 3 is a flowchart showing an example of a processing operation of the arithmetic apparatus according to the second example embodiment;

FIG. 4 is a block diagram showing an example of a control apparatus including an arithmetic apparatus according to a third example embodiment;

FIG. 5 is a flowchart showing an example of a processing operation of the arithmetic apparatus according to the third example embodiment; and

FIG. 6 is a diagram showing an example of a hardware configuration of the arithmetic apparatus.

### DESCRIPTION OF EMBODIMENTS

Example embodiments will be described hereinafter with reference to the drawings. Note that the same or equivalent components will be denoted by the same reference symbols throughout the example embodiments, and redundant descriptions will be omitted.

### First Example Embodiment

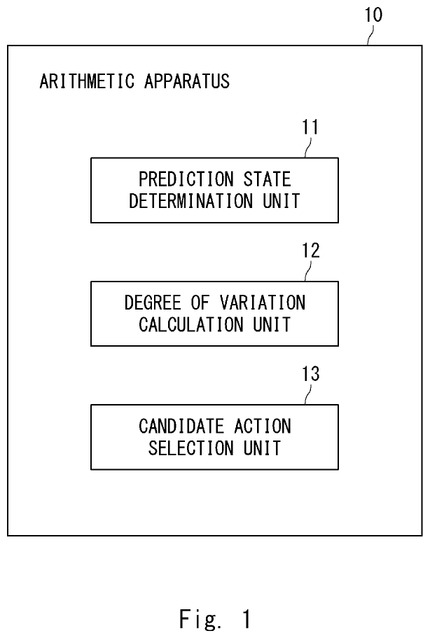

FIG. 1 is a block diagram showing an example of an arithmetic apparatus according to a first example embodiment. In FIG. 1, an arithmetic apparatus (an action determination apparatus) 10 includes a prediction state determination unit 11, a degree of variation calculation unit 12, and a candidate action selection unit 13.

For the sake of convenience of description, a state of an object to be controlled at a certain timing (hereinafter referred to as a “first timing”) is referred to as a “first state”. A state of an object to be controlled at a timing (hereinafter referred to as a “second timing”) after the certain timing is referred to as a “second state”. It is assumed that the state of an object to be controlled changes to the second state after an action corresponding to the first state has been executed. Further, the first state and the second state do not necessarily have to be different from each other, but may indicate the same state. In the following description, for the sake of convenience of description, it is defined that “a state of an object to be controlled changes from the first state to the second state” regardless of the difference between the first state and the second state. Further, the first timing and the second timing do not indicate specific timings, but indicate two timings different from each other.

The prediction state determination unit 11 determines a plurality of “prediction states” for each of a plurality of “candidate actions” that can be executed in the first state by using a plurality of pieces of state transition information (transition information units). Each transition information unit is used to calculate a prediction state at a timing after the first timing (e.g., at the second timing) based on the first state and an action executed in this first state. That is, each transition information unit holds the first state of each transition information unit, and has a function of determining a prediction state in accordance with a combination of the first state and the action. It should be noted that, for example, each transition information unit is created (trained) based on “history information” including a set in which a state (a real environmental state) of a real environment at a certain timing and an action that has been actually executed for the real environment at the certain timing are associated with each other. The set indicates information associating two states with an action between the two states.

The degree of variation calculation unit 12 calculates “degrees of variation” of the plurality of prediction states determined for each of the plurality of candidate actions by the prediction state determination unit 11. Here, since there are a plurality of candidate actions that can be executed in the first state, a plurality of degrees of variation corresponding to the plurality of candidate actions, respectively, are calculated. The “degree of variation” is, for example, a variance value.

The candidate action selection unit 13 selects some of the candidate actions among the aforementioned plurality of candidate actions based on the plurality of degrees of variation calculated by the degree of variation calculation unit 12. For example, the candidate action selection unit 13 selects, from among the aforementioned plurality of candidate actions, a candidate action corresponding to the maximum value of the plurality of degrees of variation calculated by the degree of variation calculation unit 12.

As described above, according to the first example embodiment, in the arithmetic apparatus 10, the prediction state determination unit 11 determines a plurality of “prediction states” for each of a plurality of “candidate actions” that can be executed in the first state by using a plurality of transition information units. The degree of variation calculation unit 12 calculates “degrees of variation” of the plurality of prediction states determined for each of the candidate actions by the prediction state determination unit 11. The candidate action selection unit 13 selects some of the candidate actions among the aforementioned plurality of candidate actions based on the plurality of degrees of variation calculated by the degree of variation calculation unit 12.

By the above configuration of the arithmetic apparatus 10, it is possible to perform an efficient search (exploration). That is, when a state transition from the first state to the second state caused by the candidate action is a “poorly trained state transition” in the transition information unit, the “degree of variation” for the prediction state of this state transition tends to be high. That is, the “degree of variation” can be used as an index indicating a training progress of a state transition in the transition information unit. Further, the aforementioned “poorly trained state transition” may indicate a state transition for which a sufficient number has not been accumulated in the aforementioned “history information”, in other words, a state transition for which a search (an exploration) has not been sufficiently performed in the real environment. Therefore, by selecting a candidate action based on the degree of variation, it is possible to actively search for (explore) a state transition (i.e., a combination of a state and an action) for which a search (an exploration) has not been sufficiently performed. Thus, it is possible to perform an efficient search (exploration). Further, since it is possible to actively search for (explore) a state transition for which a search (an exploration) has not been sufficiently performed, it is possible to efficiently train transition information units.

### Second Example Embodiment

A second example embodiment relates to a more specific example embodiment.

<Overview of Control Apparatus>

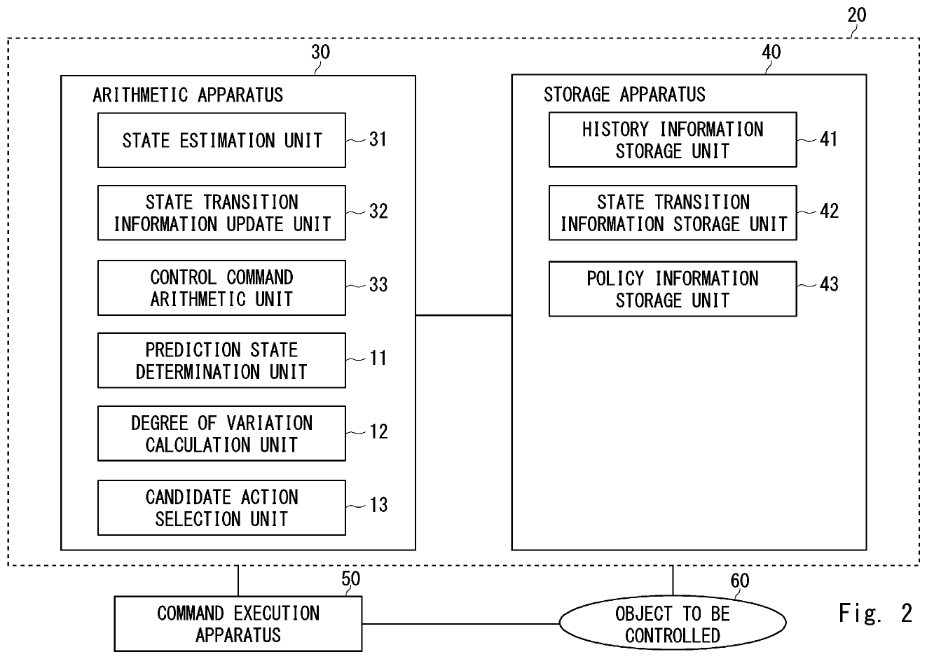

FIG. 2 is a block diagram showing an example of a control apparatus 20 including an arithmetic apparatus 30 according to the second example embodiment. FIG. 2 shows a command execution apparatus 50 and an object 60 to be controlled in addition to the control apparatus 20.

For example, when the object 60 to be controlled is a vehicle, the control apparatus 20 determines an action such as turning a steering wheel to the right, stepping on an accelerator, and stepping on a brake, based on observation values (feature values) of, for example, a rotational speed of the engine, a speed of the vehicle, and the surroundings of the vehicle. The command execution apparatus 50 controls the accelerator, the steering wheel, or the brake in accordance with the action determined by the arithmetic apparatus 30.

For example, when the object 60 to be controlled is a generator, the control apparatus 20 determines an action such as increasing the amount of fuel or reducing the amount of fuel based on observation values of, for example, a rotational speed of a turbine, a temperature of a combustion furnace, and a pressure of the combustion furnace. The command execution apparatus 50 executes control such as closing or opening a valve for adjusting the amount of fuel in accordance with the action determined by the control apparatus 20.

The object 60 to be controlled is not limited to the example described above, and may be, for example, a production plant, a chemical plant, or a simulator that simulates, for example, operations of a vehicle and operations of a generator.

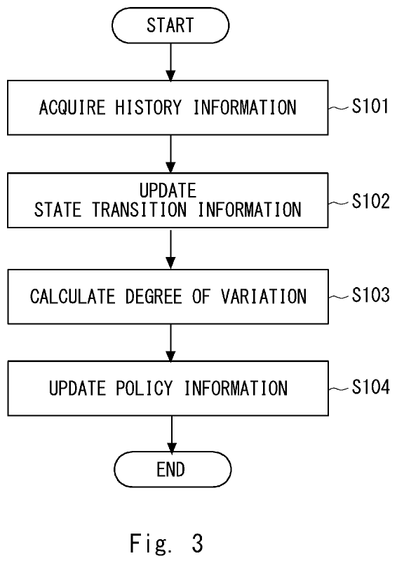

The processing for determining an action based on observation values will be described later with reference to FIG. 3.

The control apparatus 20 executes a “processing phase 1”, a “processing phase 2”, and a “processing phase 3” as described later. By executing these processing phases, the control apparatus 20 determines an action so that the state of the object 60 to be controlled approaches a desired state earlier. At this time, the control apparatus 20 determines an action to be executed in accordance with the state of the object 60 to be controlled based on policy information and reward information.

The policy information indicates an action that can be executed when the object 60 to be controlled is in a certain state. The policy information can be implemented, for example, by using information associating the certain state with the action. The policy information may be, for example, processing for calculating the action when the certain state is provided. The processing may be, for example, a certain function or a model indicating a relation between the certain state and the action, the model being calculated by a statistical method. That is, the policy information is not limited to the example described above.

The reward information indicates a degree (hereinafter referred to as a “degree of reward”) to which a certain state is desirable. The reward information can be implemented, for example, by using information associating the certain state with the degree. The reward information may be, for example, processing for calculating the degree of reward when the certain state is provided. The processing may be, for example, a certain function or a model indicating a relation between the certain state and the degree of reward, the model being calculated by a statistical method. That is, the reward information is not limited to the example described above.

In the following description, for the sake of convenience of description, it is assumed that the object 60 to be controlled is a vehicle, a generator, or the like (hereinafter referred to as a “real environment”). A state of the object 60 to be controlled at a certain timing (hereinafter referred to as a “first timing”) is referred to as a “first state”. A state of the object 60 to be controlled at a timing (hereinafter referred to as a “second timing”) following the certain timing is referred to as a “second state”. It is assumed that the state of the object 60 to be controlled changes to the second state after an action corresponding to the first state has been executed. Further, the first state and the second state do not necessarily have to be different from each other, but may indicate the same state. In the following description, for the sake of convenience of description, it is defined that “a state of the object 60 to be controlled changes from the first state to the second state” regardless of the difference between the first state and the second state.

In regard to a plurality of timings, the control apparatus 20 executes processing described later in the processing phases 1 to 3 by referring to the observation values of the object 60 to be controlled, thereby determining an action for each timing. That is, the control apparatus 20 executes the processing in regard to the first timing, then executes the processing in regard to the second timing, and further executes the processing in regard to the timing after the second timing. Therefore, the first timing and the second timing do not indicate a specific timing, but indicate two consecutive timings in regard to processing performed by the control apparatus 20.

(Processing Phase 1)

The control apparatus 20 estimates, based on state transition information (described later), the second state of the object 60 to be controlled after an action has been executed with regard to the object 60 to be controlled which is in the first state. The control apparatus 20 executes processing for estimating the second state for each of a plurality of candidate actions. After that, the control apparatus 20 calculates a degree of reward for each of the estimated second states by using reward information. The control apparatus 20 selects one of the plurality of candidate actions having higher calculated degrees of reward from among the plurality of candidate actions. The control apparatus 20 may select one action having a highest calculated degree of reward from among the plurality of candidate actions. The control apparatus 20 outputs a control command indicating the selected action to the command execution apparatus 50.

For example, the aforementioned higher degree of reward indicates a degree of reward that falls within a predetermined top percentage, such as 1%, 5%, or 10%, in a descending order of the degrees of reward.

State transition information will be described below. The state transition information is information indicating a relation between the first state and the second state. The state transition information may be information associating the first state with the second state or information calculated by a statistical method such as a neural network using training data in which the first state and the second state are associated with each other. The state transition information is not limited to the example described above, and may further include information indicating an action that can be executed in the first state.

The command execution apparatus 50 receives a control command by the control apparatus 20 and executes an action indicated by the received control command with regard to the object 60 to be controlled. As a result, the state of the object 60 to be controlled changes from the first state to the second state.

For the sake of convenience of description, it is assumed that a sensor (not shown) for observing the object 60 to be controlled is attached to the object 60 to be controlled. The sensor creates sensor information indicating observation values obtained by observing the object 60 to be controlled, and outputs the created sensor information. A plurality of sensors may observe the object 60 to be controlled.

The control apparatus 20 receives the sensor information created by the sensor after the action in regard to the first state has been executed, and determines the second state as to the received sensor information. The control apparatus 20 creates information (hereinafter referred to as “history information”) in which the first state, the action, and the second state are associated with one another. The control apparatus 20 may store the created history information in a history information storage unit 41 described later.

Regarding the processing phase 1, the above-described processing is executed in regard to a plurality of timings, whereby pieces of the history information at the plurality of timings are accumulated in the history information storage unit 41 described later.

(Processing Phase 2)

The control apparatus 20 updates (or creates) the state transition information using pieces of the history information accumulated in the processing phase 1. When the state transition information is created by using a neural network, the control apparatus 20 creates the state transition information by using data included in the history information described above as training data. As will be described later, the control apparatus 20 creates a plurality of pieces of the state transition information by using, for example, neural networks having configurations different from one another.

(Processing Phase 3)

The control apparatus 20 predicts the second state after each of a plurality of candidate actions has been executed with regard to an object based on state transition information. The control apparatus 20 predicts a plurality of second states by using pieces of the state transition information (i.e., transition information units) different from one another. For the sake of convenience of description, in order to distinguish the second state from the predicted second state, the predicted second state is referred to as a “pseudo state”. That is, the control apparatus 20 creates a pseudo state by using pieces of the state transition information (i.e., the transition information units) different from one another

When state transition information is created by using a neural network, the control apparatus 20 creates the pseudo state by applying this state transition information to at least one of information indicating the first state and information indicating the candidate actions executed in this first state.

Regarding the processing phase 3, by the processing described above, the control apparatus 20 creates a plurality of pseudo states for each of the candidate actions. The control apparatus 20 calculates degrees of variation of the plurality of pseudo states for each of the candidate actions.

The control apparatus 20 selects an action from among the plurality of candidate actions based on the degrees of variation. The control apparatus 20 specifies the candidate actions having higher calculated degrees of variation from among the plurality of candidate actions, and selects an action from among the specified candidate actions. The control apparatus 20 may select, for example, a candidate action having a highest calculated degree of variation from among the plurality of candidate actions.

For example, the aforementioned higher degree of variation indicates a degree of variation that falls within a predetermined top percentage, such as 1%, 5%, or 10%, in a descending order of the degrees of variation.

The control apparatus 20 may obtain the degree of reward in the pseudo state after one action has been executed, and select an action based on the obtained degree of reward and the degree of variation for the one action.

When there are a plurality of pseudo states, the control apparatus 20 obtains, for example, an average (or a median value) of the degrees of reward for the respective pseudo states, thereby obtaining the degree of reward for an action. Alternatively, the control apparatus 20 obtains, for example, states having higher frequencies of the respective pseudo states, and obtains an average (or a median value) of the degrees of reward for the obtained states, thereby obtaining the degree of reward for an action. For example, the aforementioned higher frequency indicates a frequency that falls within a predetermined top percentage, such as 1%, 5%, or 10%, in a descending order of the frequency. The processing for obtaining a degree of reward for an action is not limited to the above example.

Further, in processing for selecting an action based on the degree of reward for one action and the degree of variation for the one action, the degree of reward may be added to the degree of variation or a weighted average between the degree of reward and the degree of variation may be calculated. The processing for selecting an action is not limited to the above-described example.

After the control apparatus 20 selects the action, it outputs a control command indicating the selected action to the command execution apparatus 50.

The command execution apparatus 50 executes the action indicated by the received control command with regard to the object 60 to be controlled.

### Configuration Example of Control Apparatus

In FIG. 2, the control apparatus 20 includes the arithmetic apparatus 30 and a storage apparatus 40. The arithmetic apparatus 30 includes a state estimation unit 31, a state transition information update unit (state transition information creation unit) 32, a control command arithmetic unit 33, the prediction state determination unit 11, the degree of variation calculation unit 12, and the candidate action selection unit 13. The storage apparatus 40 includes the history information storage unit 41, a state transition information storage unit 42, and a policy information storage unit 43.

(Processing Phase 1)

The state estimation unit 31 receives observation values (parameter values and sensor information) indicating the first state of the object 60 to be controlled. The state estimation unit 31 estimates, based on the received sensor information and the state transition information, the second state of the object 60 to be controlled after an action has been executed with regard to the object 60 to be controlled which is in the first state. The state estimation unit 31 executes processing for estimating the second state for each action in a plurality of candidate actions. That is, the state estimation unit 31 creates a pseudo state for each candidate action.

The control command arithmetic unit 33 calculates a degree of reward for each pseudo state created by the state estimation unit 31 using reward information. The control command arithmetic unit 33 selects one of the plurality of candidate actions having higher calculated degrees of reward. The control command arithmetic unit 33 creates a control command indicating the selected action, and outputs the created control command to the command execution apparatus 50.

The command execution apparatus 50 receives the control command and executes an action with regard to the object 60 to be controlled in accordance with the action indicated by the received control command. As a result of the action with regard to the object 60 to be controlled, the state of the object 60 to be controlled changes from the first state to the second state.

The state estimation unit 31 receives observation values (parameter values and sensor information) indicating the state (in this case, the second state) of the object 60 to be controlled. The state estimation unit 31 creates history information in which the first state, the action that has been executed in the first state, and the second state are associated with one another, and stores the created history information in the history information storage unit 41.

Regarding the processing phase 1, by repeating the above-described processing, pieces of the history information are accumulated in the history information storage unit 41.

(Processing Phase 2)

Processing performed in a processing phase 2 will be described, for the sake of convenience of description, by using an example in which state transition information is created using a statistical method (a predetermined processing procedure) such as a neural network. The predetermined processing procedure is, for example, a procedure in accordance with a machine learning method such as a neural network.

The state transition information update unit 32 creates a plurality of transition information units in accordance with the predetermined processing procedure by using pieces of the history information accumulated in the history information storage unit 41. That is, the state transition information update unit 32 creates state transition information in accordance with the predetermined processing procedure using the history information as training data, and stores the created state transition information in the state transition information storage unit 42. As described above, the state transition information indicates a relation between the first state and the second state.

For example, the state transition information update unit 32 may create the plurality of transition information units by using a plurality of neural networks having configurations different from one another. The plurality of neural networks having configurations different from one another are, for example, a plurality of neural networks having numbers of nodes different from one another or connection patterns between the nodes different from one another. Further, the plurality of neural networks having configurations different from one another may be implemented by using a certain neural network and a neural network in which some nodes in the certain neural network are not present (i.e., some nodes have been dropped out).

The state transition information update unit 32 may create the plurality of transition information units by using a plurality of neural networks having initial values of parameters different from one another.

The state transition information update unit 32 may use, as training data, some data of the history information or data sampled from the history information while allowing duplication thereof. In this case, the plurality of transition information units create state transition information for pieces of training data different from one another.

Note that the predetermined processing procedure is not limited to a neural network. For example, the predetermined processing procedure may be a procedure for calculating a support vector machine (SVM), a random forest, bagging (bootstrap aggregating), or a Bayesian network.

(Processing Phase 3)

The prediction state determination unit 11 predicts the second state after each of a plurality of candidate actions has been executed with regard to an object based on state transition information. The prediction state determination unit 11 creates a plurality of pseudo states by using pieces of the state transition information (i.e., transition information units) different from one another.

The degree of variation calculation unit 12 calculates the degrees of variation (e.g., variance values and entropy) of the plurality of pseudo states created by the prediction state determination unit 11, and outputs the calculated degrees of variation to the candidate action selection unit 13. The degree of variation is not limited to the above example, and may be, for example, a value obtained by adding a certain number to a variance value.

The candidate action selection unit 13 selects an action from among the plurality of candidate actions based on the degrees of variation. The candidate action selection unit 13 specifies the candidate actions having higher calculated degrees of variation from among the plurality of candidate actions, and selects an action from among the specified candidate actions. The candidate action selection unit 13 may select, for example, a candidate action having a highest calculated degree of variation from among the plurality of candidate actions.

The control command arithmetic unit 33 creates a control command indicating the action selected by the candidate action selection unit 13, and outputs the created control command to the command execution apparatus 50.

As described above, the candidate action selection unit 13 selects an action having a high degree of variation. The degree of variation indicates that the results calculated in accordance with the state transition information vary. Therefore, when the degree of variation is high, it can be said that the state transition information is unstable. That is, by executing an action having a high degree of variation, it is possible to actively search (explore) for a state transition for which a search (an exploration) has not been sufficiently performed.

The candidate action selection unit 13 may create, based on state value information, the state value information indicating a degree of value for a state. The state value information is, for example, a function indicating, in regard to a state, the degree of value of the state. In this case, it can be said that the value is information indicating the degree to which it is desirable to achieve the state. It can also be said that the state value information is information indicating how desirable the state of the object 60 to be controlled after execution of an action is. It can further be said that the state value information is information indicating how desirable the action is.

The candidate action selection unit 13 may use reward information in the processing for creating state value information. For example, the candidate action selection unit 13 may newly set, as state value information, the degree of variation calculated for each action. For example, the candidate action selection unit 13 may set the degree of variation calculated for each action as state value information, and then update the state value information by executing processing such as adding thereto reward information for the action. In this case, it can be said that the degree of variation is an additional reward (a pseudo additional reward) for the reward information.

The processing for creating state value information is not limited to the above-described example, and may be executed based on, for example, a value obtained by adding a predetermined value to reward information, a value obtained by subtracting a predetermined value from reward information, or a value obtained by multiplying reward information by a predetermined value. That is, the state value information may be information indicating that the degree of value becomes higher as the degree of variation becomes higher.

The candidate action selection unit 13 may select candidate actions having higher degrees of value from among the plurality of candidate actions based on state value information, and select an action from among the selected candidate actions. The candidate action selection unit 13 may select, for example, a candidate action having a highest calculated degree of value. In this case, the aforementioned higher degree of value indicates a degree of value that falls within a predetermined top percentage, such as 1%, 5%, or 10%, in a descending order of the degrees of value.

After a control command is created, the command execution apparatus 50 receives the control command and executes the action with regard to the object 60 to be controlled in accordance with the action indicated by the received control command. As a result of the action with regard to the object 60 to be controlled, the state of the object 60 to be controlled changes from the first state to the second state.

The state estimation unit 31 receives observation values (parameter values, sensor information) indicating the state (in this case, the second state) of the object 60 to be controlled. The state estimation unit 31 creates history information in which the first state, the action that has been executed in the first state, and the second state are associated with one another, and stores the created history information in the history information storage unit 41.

Regarding the processing phase 3, the above-described processing is executed in regard to a plurality of timings, whereby a pieces of the history information at the plurality of timings are accumulated in a history information storage unit (not shown).

<Operation Example of Control Apparatus>

An example of a processing operation of the arithmetic apparatus 30 having the above-described configuration will be described. FIG. 3 is a flowchart showing the example of the processing operation of the arithmetic apparatus according to the second example embodiment. In the flowchart shown in FIG. 3, Step S101 corresponds to the aforementioned processing phase 1, Step S102 corresponds to the aforementioned processing phase 2, and Steps S103 and S104 correspond to the aforementioned processing phase 3.

The arithmetic apparatus 30 repeats at least one of the processing phases 1 and 2 and the processing phases 3 and 2 until pieces of history information are accumulated, thereby acquiring the history information (Step S101).

The arithmetic apparatus 30 updates state transition information in accordance with the processing described in the processing phase 2 (Step S102).

The arithmetic apparatus 30 calculates the degree of variation in accordance with the processing described in the above processing phase 3 (Step S103).

The arithmetic apparatus 30 updates policy information based on the history information (Step S104). Specifically, the arithmetic apparatus 30 specifies a first state, an action that has been executed in the first state, and a second state based on the history information, and updates the policy information using these specified pieces of information. Then, the processing step returns to Step S101 (the processing phase 1).

Note that the above description has been given in accordance with the assumption that the arithmetic apparatus 30, in the processing phase 3, accumulates pieces of the history information, then updates the policy information, and immediately thereafter the process returns to the processing phase 1. For the sake of convenience of description, in this example embodiment, the processing described above with reference to FIG. 3 is referred to as “batch learning”. That is, batch learning indicates processing for accumulating pieces of history information to a certain degree (referred to as a “first degree of accumulation” for the sake of convenience of description), and then updating (or creating) policy information using the history information. The first degree of accumulation indicates that there are a plurality of histories. However, the processing performed by the arithmetic apparatus 30 is not limited to the batch learning described above, and for example, the policy information may be updated (or created) by online learning or may be updated (or created) by mini-batch learning.

Online learning indicates processing for updating (or creating), each time one history is added to history information, policy information using the history information.

Mini-batch learning indicates processing for accumulating pieces of history information to a certain degree (referred to as a “second degree of accumulation” for the sake of convenience of description), and then updating (or creating) policy information using the history information. The second degree of accumulation indicates that there are a plurality of histories. Mini-batch learning is processing similar to batch learning. However, the second degree of accumulation is lower than the first degree of accumulation.

Each of the first degree of accumulation and the second degree of accumulation may not necessarily be a fixed degree for each iterative processing described in the processing phases 1 to 3, and may indicate numbers different for each iterative processing.

In the case of online learning, a flowchart may be modified so that the policy information is updated each time the history information is acquired and then the process returns to Step S101 (the processing phase 1). That is, in the case of online learning, the candidate action selection unit 13 updates a policy model each time sensor information about the second state is received.

“Mini-batch learning” is the same as the processing operation of the aforementioned “online learning” except for the update timing of policy information. That is, since the amount of history information used to update policy information once in “mini-batch learning” is larger than that in “online learning”, the update cycle of policy information in “mini-batch learning” is longer than that in “online learning”.

### Third Example Embodiment

A third example embodiment relates to a more specific example embodiment. That is, the third example embodiment relates to variations of the second example embodiment.

<Overview of Control Apparatus>

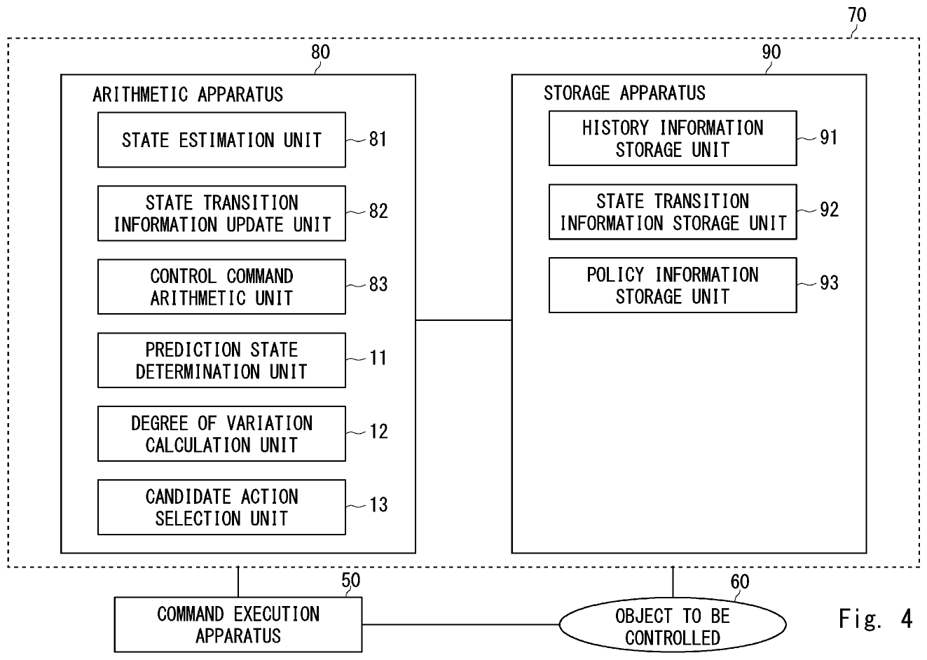

FIG. 4 is a block diagram showing an example of a control apparatus 70 including an arithmetic apparatus 80 according to the third example embodiment. FIG. 4 shows, in addition to the control apparatus 70, the command execution apparatus 50 and the object 60 to be controlled like in FIG. 2.

The control apparatus 70 executes a “processing phase 1”, a “processing phase 2”, and a “processing phase 3” as described later. By executing these processing phases, the control apparatus 70 learns policy information so that the state of the object 60 to be controlled approaches a desired state earlier.

The policy information indicates an action that can be executed when the object 60 to be controlled is in a certain state. The policy information can be implemented, for example, by using information in which the certain state is associated with the action. The policy information may be, for example, processing for calculating the action when the certain state is provided. The processing may be, for example, a certain function or a model indicating a relation between the certain state and the action, the model being calculated by a statistical method. That is, the policy information is not limited to the example described above.

In the following description, for the sake of convenience of description, it is assumed that the object 60 to be controlled is a vehicle, a generator, or the like (hereinafter referred to as a “real environment”). A state of the object 60 to be controlled at a certain timing (hereinafter referred to as a “first timing”) is referred to as a “first state”. A state of the object 60 to be controlled at a timing (hereinafter referred to as a “second timing”) following the certain timing is referred to as a “second state”. It is assumed that the state of the object 60 to be controlled changes to the second state after an action corresponding to the first state has been executed. Further, the first state and the second state do not necessarily have to be different from each other, but may indicate the same state. In the following description, for the sake of convenience of description, it is defined that “a state of the object 60 to be controlled changes from the first state to the second state” regardless of the difference between the first state and the second state.

In the “processing phase 1” described later, the control apparatus 70 executes processing described later in regard to a plurality of timings by referring to the state of the object 60 to be controlled, thereby determining an action for each timing. That is, the control apparatus 70 executes the processing in regard to the first timing, then executes the processing in regard to the second timing, and further executes the processing in regard to the timing after the second timing. Therefore, the first timing and the second timing do not indicate a specific timing, but indicate two consecutive timings in regard to processing performed by the control apparatus 70.

(Processing Phase 1)

The control apparatus 70 determines an action with regard to the object 60 to be controlled which is in the first state based on the first state and policy information, and outputs a control command indicating the determined action to the command execution apparatus 50.

The command execution apparatus 50 receives the control command from the control apparatus 70 and executes an action indicated by the received control command with regard to the object 60 to be controlled. As a result, the state of the object 60 to be controlled changes from the first state to the second state.

For the sake of convenience of description, it is assumed that a sensor (not shown) for observing the object 60 to be controlled is attached to the object 60 to be controlled. The sensor creates sensor information indicating observation values obtained by observing the object 60 to be controlled, and outputs the created sensor information. A plurality of sensors may observe the object 60 to be controlled.

The control apparatus 70 receives the sensor information created by the sensor after the action in regard to the first state has been executed, and estimates the second state as to the received sensor information. The control apparatus 70 creates information (hereinafter referred to as “history information”) in which the first state, the action, and the second state are associated with one another. The control apparatus 70 may store the created history information in a history information storage unit 91 described later.

Regarding the processing phase 1, the above-described processing is executed in regard to a plurality of timings, whereby a pieces of the history information at the plurality of timings are accumulated in the history information storage unit 41 described later.

(Processing Phase 2)

The control apparatus 70 updates (or creates) the state transition information using pieces of the history information accumulated in the processing phase 1. When the state transition information is created by using a neural network, the control apparatus 70 creates the state transition information by using data included in the history information described above as training data. As will be described later, the control apparatus 70 creates a plurality of pieces of the state transition information by using, for example, neural networks having configurations different from one another.

State transition information will be described below. The state transition information is information indicating a relation between the first state and the second state, and is obtained, for example, by modeling a state transition (i.e., a state transition from the first state to the second state caused by an action) of the object 60 to be controlled using history information. That is, by using the state transition information, it is possible to predict the second state corresponding to a combination of the first state and the action. In the following description, in order to distinguish the first state of the object 60 to be controlled from the second state thereof, the first state and the second state of the state transition information may be referred to as a “first pseudo state” and a “second pseudo state”, respectively. Further, the “second pseudo state” may be referred to as a “prediction state”.

(Processing Phase 3)

The control apparatus 70 determines a plurality of “prediction states” for each of a plurality of “candidate actions” that can be executed in the first pseudo state based on state transition information. The control apparatus 70 creates a plurality of second pseudo states by using pieces of the state transition information (i.e., transition information units) different from one another.

When state transition information is created by using a neural network, the control apparatus 70 creates the second pseudo state by applying this state transition information to information indicating the first pseudo state and the candidate actions executed in this first pseudo state.

Regarding the processing phase 3, by the processing described above, the control apparatus 70 creates a plurality of prediction states for each of the candidate actions. The control apparatus 70 calculates degrees of variation of the plurality of prediction states for each of the candidate actions.

The control apparatus 70 selects an action from among the plurality of candidate actions based on the degrees of variation. Since the selected action is used to update policy information as described later, the selected action may be referred to as an “update use action” in the following description. The control apparatus 70 specifies the candidate actions having higher calculated degrees of variation from among the plurality of candidate actions, and selects an update use action from among the specified candidate actions. The control apparatus 70 may select, for example, a candidate action having a highest calculated degree of variation from among the plurality of candidate actions.

For example, the aforementioned higher degree of variation indicates a degree of variation that falls within a predetermined top percentage, such as 1%, 5%, or 10%, in a descending order of the degrees of variation.

The control apparatus 70 may obtain the degree of reward in the prediction state after one candidate action has been executed, and select the update use action based on the obtained degree of reward and the degree of variation for the one candidate action. The reward information indicates a degree (i.e., the “degree of reward”) to which a certain state is desirable. The reward information can be implemented, for example, by using information in which the certain state is associated with the degree. The reward information may be, for example, processing for calculating the degree of reward when the certain state is provided. The processing may be, for example, a certain function or a model indicating a relation between the certain state and the degree of reward, the model being calculated by a statistical method. That is, the reward information is not limited to the example described above.

When there are a plurality of prediction states, the control apparatus 70 obtains, for example, an average (or a median value) of the degrees of reward for the respective prediction state, thereby obtaining the degree reward for a candidate action. Alternatively, the control apparatus 70 obtains, for example, states having higher frequencies of the respective prediction states, and obtains an average (or a median value) of the degrees of reward for the obtained states, thereby obtaining the degree of reward for a candidate action. For example, the aforementioned higher frequency indicates a frequency that falls within a predetermined top percentage, such as 1%, 5%, or 10%, in a descending order of the frequency. The processing for obtaining a degree of reward for a candidate action is not limited to the above example.

Further, in processing for selecting an update use action based on the degree of reward for one candidate action and the degree of variation for the one candidate action, the degree of reward may be added to the degree of variation, or a weighted average between the degree of reward and the degree of variation may be calculated. The processing of selecting an update use action is not limited to the above-described example.

The control apparatus 70 updates policy information based on an update use action. For example, the control apparatus 70 updates the policy information so that the update use action is deterministically selected or there is a higher probability of it being selected than those of other actions in the processing phase 1. This updated policy information is used in the processing phase 1.

<Configuration Example of Control Apparatus>

In FIG. 4, the control apparatus 70 includes the arithmetic apparatus 80 and a storage apparatus 90. The arithmetic apparatus 30 includes a state estimation unit 81, a state transition information update unit (state transition information creation unit) 82, a control command arithmetic unit 83, the prediction state determination unit 11, the degree of variation calculation unit 12, and the candidate action selection unit 13. The storage apparatus 90 includes the history information storage unit 91, a state transition information storage unit 92, and a policy information storage unit 93. The configuration of the control apparatus 70 will be described below for each processing phase.

(Processing Phase 1)

The state estimation unit 81 receives observation values (parameter values and sensor information) indicating the state of the object 60 to be controlled. The state estimation unit 81 estimates the state of the object 60 to be controlled based on the received observation values (parameter values and sensor information).

The control command arithmetic unit 83 determines an action based on the state estimated by the state estimation unit 81 and policy information stored in the policy information storage unit 93, and outputs a control command indicating the determined action to the command execution apparatus 50. The command execution apparatus 50 receives the control command from the control apparatus 70 and executes an action indicated by the received control command with regard to the object 60 to be controlled. As a result, the state of the object 60 to be controlled changes from the first state to the second state.

The state estimation unit 81 receives observation values (parameter values and sensor information) indicating the state (in this case, the second state) of the object 60 to be controlled. The state estimation unit 81 creates history information in which the first state, the action that has been executed in the first state, and the second state are associated with one another, and stores the created history information in the history information storage unit 91.

Regarding the processing phase 1, by repeating the above-described processing, pieces of the history information are accumulated in the history information storage unit 91.

(Processing Phase 2)

The configuration of the control apparatus 70 corresponding to a processing phase 2 will be described, for the sake of convenience of description, by using an example in which state transition information is created using a statistical method (a predetermined processing procedure) such as a neural network. The predetermined processing procedure is, for example, a procedure in accordance with a machine learning method such as a neural network.

The state transition information update unit 82 creates a plurality of pieces of transition information in accordance with the predetermined processing procedure by using pieces of the history information accumulated in the history information storage unit 91. That is, the state transition information update unit 82 creates state transition information in accordance with the predetermined processing procedure using the pieces of the history information as training data, and stores the created state transition information in the state transition information storage unit 92. As described above, the state transition information indicates a relation between the first state and the second state.

For example, the state transition information update unit 82 may create a plurality of transition information units using a plurality of neural networks having configurations different from one another. The plurality of neural networks having configurations different from one another are, for example, a plurality of neural networks having the numbers of nodes different from one another or connection patterns between the nodes different from one another. Further, the plurality of neural networks having configurations different from one another may be implemented by using a certain neural network and a neural network in which some nodes in the certain neural network are not present (i.e., some nodes have been dropped out).

The state transition information update unit 82 may create the plurality of transition information units by using a plurality of neural networks having initial values of parameters different from one another.

The state transition information update unit 82 may use, as training data, some data of the history information or data sampled from the history information while allowing duplication thereof. In this case, the plurality of transition information units create pieces of state transition information for pieces of training data different from one another.

Note that the predetermined processing procedure is not limited to a neural network. For example, the predetermined processing procedure may be a procedure for calculating a support vector machine (SVM), a random forest, bagging (bootstrap aggregating), or a Bayesian network.

(Processing Phase 3)

The control command arithmetic unit 83 outputs a plurality of control commands each indicating a plurality of candidate actions that can be executed in the first pseudo state to the prediction state determination unit 11.

The prediction state determination unit 11 determines a plurality of prediction states for each of a plurality of “candidate actions” that can be executed in the first pseudo state based on the plurality of candidate actions that can be executed in the first pseudo state and state transition information. The control apparatus 70 creates a plurality of second pseudo states for each candidate action by using pieces of state transition information (i.e., transition information units) different from one another.

The control command arithmetic unit 83 sets each of the second pseudo states created by the prediction state determination unit 11 as a new first pseudo state and outputs a plurality of control commands each indicating the plurality of candidate actions that can be executed in the new first pseudo state to the prediction state determination unit 11. At this time, for example, the control command arithmetic unit 83 may set, as a new first pseudo state, each second state information created using one of a plurality of pieces of state transition information by the prediction state determination unit 11.

By the above-described communication between the control command arithmetic unit 83 and the prediction state determination unit 11, the degrees of variation respectively corresponding to the combinations of the first pseudo state, the second pseudo state, and the candidate action are accumulated in the candidate action selection unit 13.

The degree of variation calculation unit 12 calculates the degrees of variation (e.g., variance values, entropy, etc.) of the plurality of prediction states created by the prediction state determination unit 11, and outputs the calculated degrees of variation to the candidate action selection unit 13. The degree of variation is not limited to the above example, and may be, for example, a value obtained by adding a certain number to a variance value.

The candidate action selection unit 13 selects an update use action from among the plurality of candidate actions based on the degrees of variation. The candidate action selection unit 13 specifies the candidate actions having higher calculated degrees of variation, for example, from among the plurality of candidate actions, and selects an update use action from among the specified candidate actions. The candidate action selection unit 13 may select, for example, a candidate action having a highest calculated degree of variation from among the plurality of candidate actions.

The candidate action selection unit 13 updates policy information based on an update use action. For example, the candidate action selection unit 13 updates the policy information stored in the policy information storage unit 93 so that the update use action is deterministically selected or there is a higher probability of it being selected than those of other actions by the control command arithmetic unit 83 in the processing phase 1.

As described above, the candidate action selection unit 13 selects a candidate action having a high degree of variation. The degree of variation indicates that the results calculated in accordance with the state transition information vary. Therefore, when the degree of variation is high, it can be said that the state transition information is unstable. That is, by executing an action having a high degree of variation, it is possible to actively search (explore) for a state transition for which a search (an exploration) has not been sufficiently performed.

The candidate action selection unit 13 may create state value information indicating a degree of value for a state based on state value information. The state value information is, for example, a function indicating, in regard to a state, the degree of value of the state. In this case, it can be said that the value is information indicating the degree to which it is desirable to achieve the state. It can also be said that the state value information is information indicating how desirable the state of the object 60 to be controlled after execution of an action is. It can further be said that the state value information is information indicating how desirable the action is.

The candidate action selection unit 13 may use reward information in the processing for creating state value information. For example, the candidate action selection unit 13 may newly set, as state value information, the degree of variation calculated for each candidate action. For example, the candidate action selection unit 13 may set the degree of variation calculated for each candidate action as state value information, and then update the state value information by executing processing such as adding thereto reward information for the candidate action. In this case, it can be said that the degree of variation is an additional reward (a pseudo additional reward) for the reward information.

The processing for creating state value information is not limited to the above-described example, and may be executed based on, for example, a value obtained by adding a predetermined value to reward information, a value obtained by subtracting a predetermined value from reward information, or a value obtained by multiplying reward information by a predetermined value. That is, the state value information may be information indicating that the value becomes higher as the degree of variation becomes higher.

The candidate action selection unit 13 may select candidate actions having higher degrees of value from among the plurality of candidate actions based on state value information, and select an update use action from the selected candidate actions. The candidate action selection unit 13 may select, for example, a candidate action having a highest calculated degree of value. In this case, the aforementioned higher degree of value indicates a degree of value that falls within a predetermined top percentage, such as 1%, 5%, or 10%, in a descending order of the degrees of value.

<Operation Example of Control Apparatus>

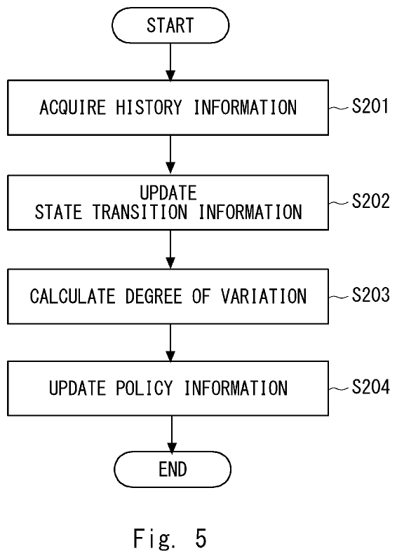

An example of a processing operation of the arithmetic apparatus 80 having the above-described configuration will be described. FIG. 5 is a flowchart showing the example of the processing operation of the arithmetic apparatus according to the third example embodiment. In the flowchart shown in FIG. 5, Step S201 corresponds to the aforementioned processing phase 1, Step S202 corresponds to the aforementioned processing phase 2, and Steps S203 and S204 correspond to the aforementioned processing phase 3.

The arithmetic apparatus 80 repeats the processing described in the processing phase 1 until pieces of history information are accumulated, thereby acquiring the history information (Step S201).

The arithmetic apparatus 80 updates state transition information by the processing described in the processing phase 2 (Step S202).

The arithmetic apparatus 80 calculates the degree of variation by the processing described in the processing phase 3 until the degrees of variation are accumulated (Step S203).

The arithmetic apparatus 80 updates policy information based on the degree of variation (Step S204). Then, the processing step returns to Step S201 (the processing phase 1).

Note that the above description has been given in accordance with the assumption that the arithmetic apparatus 80, in the processing phase 3, accumulates the degrees of variation, then updates the policy information, and immediately thereafter the process returns to the processing phase 1. That is, in the above description, although a case in which the policy information is learned by batch learning has been described as an example, the present disclosure is not limited to this case. For example, the policy information may be learned by online learning or may be learned by mini-batch learning.

In the case of “online learning”, the flowchart shown in FIG. 5 may be modified so that the processing of Steps S203 and S204 is repeated as a loop and then the process returns to Step S201 (the processing phase 1) on the condition that the loop is repeated a predetermined number of times. That is, in the case of “online learning”, the candidate action selection unit 13 updates the policy information each time the degree of variation is received.

In the case of “mini-batch learning”, as in the case of “online learning”, the flowchart shown in FIG. 5 may be modified so that the processing of Steps S203 and S204 are repeated as a loop and then the process returns to Step S201 (the processing phase 1) on the condition that the loop is repeated a predetermined number of times. However, in the case of “mini-batch learning”, unlike in the case of “online learning”, the candidate action selection unit 13 updates the policy information at the timing when a plurality of degrees of variation have been accumulated.

### Other Example Embodiments

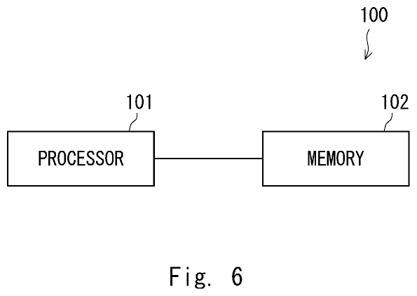

FIG. 6 is a diagram showing an example of a hardware configuration of an arithmetic apparatus. In FIG. 6, an arithmetic apparatus 100 includes a processor 101 and a memory 102. The state estimation units 31 and 81 of the arithmetic apparatuses 10, 30, and 80, the state transition information update units (the state transition information creation units) 32 and 82, the control command arithmetic units 33 and 83, the prediction state determination unit 11, the degree of variation calculation unit 12, and the candidate action selection unit 13 that have been described in the example embodiments 1 and 2 may be implemented by the processor 101 loading and executing a program stored in the memory 102. The program can be stored and provided to the arithmetic apparatuses 10, 30, and 80 using any type of non-transitory computer readable media. Further, the program may be provided to the arithmetic apparatuses 10, 30, and 80 using any type of transitory computer readable media.

The above-described arithmetic apparatus can also function as, for example, a control apparatus that controls apparatuses in manufacturing plants. In this case, in each manufacturing plant, a sensor for measuring, for example, the state of each apparatus and the conditions (e.g., a temperature, humidity, and visibility) in the manufacturing plant is disposed. Each sensor measures, for example, the state of each apparatus or the conditions in the manufacturing plant and creates observation information indicating the measured states and conditions. In this case, the observation information is information indicating the states and the conditions observed in the manufacturing plant.

The arithmetic apparatus receives the observation information and controls each apparatus in accordance with an action determined by performing the processing described above. For example, when the apparatus is a valve for adjusting the amount of material, the arithmetic apparatus performs control such as closing or opening a valve in accordance with the determined action. Alternatively, when the apparatus is a heater for adjusting the temperature, the arithmetic apparatus performs control such as raising the set temperature or reducing the set temperature in accordance with the determined action.

Although a control example has been described with reference to an example in which apparatuses are controlled in a manufacturing plant, the control example is not limited to the example described above. For example, the arithmetic apparatus can also function as a control apparatus that controls apparatuses in a chemical plant or a control apparatus that controls apparatuses in a power plant by performing processing similar to that described above.

Although the present disclosure has been described with reference to the example embodiments, the present disclosure is not limited by the above. The configuration and details of the present disclosure may be modified in various ways as will be understood by those skilled in the art within the scope of the disclosure.

### REFERENCE SIGNS LIST

10, 30, 80 ARITHMETIC APPARATUS (ACTION DETERMINATION APPARATUS)
11 PREDICTION STATE DETERMINATION UNIT
12 DEGREE OF VARIATION CALCULATION UNIT
13 CANDIDATE ACTION SELECTION UNIT
20, 70 CONTROL APPARATUS
31, 81 STATE ESTIMATION UNIT
32, 82 STATE TRANSITION INFORMATION UPDATE UNIT (STATE TRANSITION INFORMATION CREATION UNIT)
33, 83 CONTROL COMMAND ARITHMETIC UNIT
40, 90 STORAGE APPARATUS
41, 91 HISTORY INFORMATION STORAGE UNIT
42, 92 STATE TRANSITION INFORMATION STORAGE UNIT
43, 93 POLICY INFORMATION STORAGE UNIT
50 COMMAND EXECUTION APPARATUS
60 OBJECT TO BE CONTROLLED

What is claimed is:

1. An arithmetic apparatus comprising:
hardware including at least one processor and at least one memory;
determination unit implemented at least by the hardware and that determines, by using a plurality of pieces of transition information each indicating a relation between a first state at a first timing and a second state at a second timing after the first timing, a plurality of the second states for each of a plurality of candidate actions that can be executed in the first state;
calculation unit implemented at least by the hardware and that calculates degrees of variation of the plurality of the second states for each of the candidate actions; and
selection unit implemented at least by the hardware and that selects some of the candidate actions from among the plurality of the candidate actions based on the degrees of variation.

2. The arithmetic apparatus according to claim 1, wherein the selection unit selects the candidate actions having higher degrees of variation as the some of the candidate actions from among the plurality of candidate actions.

3. The arithmetic apparatus according to claim 1, wherein the selection unit selects the candidate action having the highest degree of variation from among the some of the candidate actions.

4. The arithmetic apparatus according to claim 1 further comprising creation unit implemented at least by the hardware and that creates the transition information in accordance with a predetermined processing procedure based on history information including a set in which two states and an action between the two states are associated with each other.

5. The arithmetic apparatus according to claim 4, wherein the predetermined processing procedure is a procedure for calculating a neural network.

6. The arithmetic apparatus according to claim 5, wherein the creation unit creates the plurality of pieces of the transition information by using a plurality of the neural networks having configurations different from one another.

7. The arithmetic apparatus according to claim 5, wherein the creation unit creates the plurality of pieces of the transition information by using the plurality of the neural networks having initial values of parameters different from one another.

8. The arithmetic apparatus according to claim 5, wherein the plurality of pieces of the transition information are created by inputting sets of pieces of the history information different from one another into the plurality of the neural networks.

9. An action determination method comprising:
causing an information processing apparatus to determine, by using a plurality of pieces of transition information each indicating a relation between a first state at a first timing and a second state at a second timing after the first timing, a plurality of the second states for each of a plurality of candidate actions that can be executed in the first state;
calculating degrees of variation of the plurality of the second states for each of the candidate actions; and
selecting some of the candidate actions from among the plurality of the candidate actions based on the degrees of variation.

10. A non-transitory computer readable medium storing a control program for causing an arithmetic apparatus to:
determine, by using a plurality of pieces of transition information each indicating a relation between a first state at a first timing and a second state at a second timing after the first timing, a plurality of the second states for each of a plurality of candidate actions that can be executed in the first state;
calculate degrees of variation of the plurality of the second states for each of the candidate actions; and
select some of the candidate actions from among the plurality of the candidate actions based on the degrees of variation.
